(19) United States
(12) Patent Application Publication
(10) Pub. No.: US 2011/0198015 A1
(43) Pub. Date: Aug. 18, 2011

(54) Visually Enhanced Paint using Luminescence

(76) Inventors: Dennis Lee Anderson, Naperville, IL (US); Larry Patrick Anderson, Lakota, ND (US)

(21) Appl. No.: 13/029,433

(22) Filed: Feb. 17, 2011

Related U.S. Application Data
(60) Provisional application No. 61/338,283, filed on Feb. 17, 2010.

(51) Int. Cl. C09K 11/00

(52) U.S. Cl. 156/67

(57) ABSTRACT

This invention provides designs which can be applied to surfaces, especially the surfaces of vehicles, in which the designs can partially or completely light up, due to the use of electroluminescent material, and a method for installing such designs. The designs are not limited to applications on vehicles, but can be applied to any surface that can be painted.

### CROSS-REFERENCED TO RELATED APPLICATIONS

This application claims benefit of Provisional Application Ser. No. 61/338,283, filed Feb. 17, 2010, hereby incorporated by reference.

### TECHNICAL FIELD

This invention relates to the field of painted decorations, designs and graphics, and specifically to painted decorations, designs and graphics that cover electroluminescent material, which allows the decoration, design or graphic to light up when connected to a power supply.

### BACKGROUND

Thin film electroluminescent lamps are well known. However, they have generally been used for lighting stationary objects. This invention allows the electroluminescent technology to be used to apply designs, which are capable of lighting up, to vehicles and other non-stationary objects, along with other non-traditional surfaces.

Normally, electroluminescent material is too thick to allow it to be used on surfaces such as those of vehicles, mostly due to the protective lamination on the electroluminescent material. Using non-laminated electroluminescent material solves the thickness problem, but creates others, as the material can be degraded by paint and coating ingredients, and can fail due to moisture incursion. High temperatures, such as those experienced by exposed surfaces of vehicles sitting in the sun, can cause adhesives to break down. However, encasing the electroluminescent material in specifically chosen layers can overcome these problems. It also allows the design to be made to be flush with the surface of the vehicle or other object, thus increasing its durability and improving its appearance.

One anticipated use for this invention is to personalize cars, motorcycles and other vehicles. Many people already customize their vehicles with custom paint jobs, spinners on the wheels, raised chassis, lighted trim and other adornments. This invention allows a new method of customization: applying a custom paint job including a design capable of lighting up, to the surface of a vehicle or other item to which the design is to be applied. The design is applied in a series of layers, one of which is a non-laminated polymer coated phosphor tape or other electroluminescent material. The electroluminescent material is attached to a power source. When the electroluminescent material is lit, it lights up the design which has been painted on it. Because the design is embedded within layers of paint and other coatings, it sits flush with the surface to which it has been applied. It is covered with other layers of paint and coatings, thus making it permanent, while also protecting the non-laminated electroluminescent material from weather or other damage.

### SUMMARY

The current invention is intended to provide a new and unique method of installing or applying lighted designs to vehicles and other non-stationary objects, along with other surfaces on which electroluminescent material has not traditionally been used. These surfaces can include the exterior of a car, motorcycle or other vehicle, interior or exterior signage, tractor/trailer rigs, construction vans, service trucks, moving billboards or any surface that can be painted. This method can result in one-of-a-kind designs on the surface of the vehicle or other article to be painted. The fact that the design can light-up makes it more noticeable and eye-catching than regular custom paint jobs. Electroluminescent material provides a crisp, high-visibility light. When used on a vehicle, it can be used in addition to lighted trim features.

### BRIEF DESCRIPTION OF THE DRAWINGS

FIG. 1 is a side view of the different layers that are applied to a surface to which a design or graphic will be applied in the first embodiment of this invention in which catalyzed primer is used to raise a portion of the surface to make it flush with the surrounding surface.

FIG. 2 is a side view of the layers that are applied up to and including the temporary masking on the design.

FIG. 3 is a side view of the different layers that are applied to a surface to which a design or graphic will be applied in an alternate embodiment of this invention, in which a two-part non-metallic glaze is used to raise a portion of the surface to make it flush with the surrounding surface.

FIG. 4 is a side view of three layers that are put together separately prior to being installed on the surface.

FIG. 5 is a schematic diagram of the wiring of the design.

### DETAILED DESCRIPTION OF THE DRAWINGS

FIG. 1 shows the different layers of paint and other coatings and materials that are applied to a surface during the process of applying the lighted design in accordance with this invention. The term, “lighted design” or “design” in this application refers to a design, artwork or graphic made according to this invention that is capable of lighting up when connected to a power source and that is applied to the surface. Multiple layers of various substances must be applied in order to achieve the right effect, and to have the design sit flush with the surface of the vehicle or other object to which the lighted design is being applied. The layers also enable the design to resist temperature extremes and moisture incursion, and provide a safe surface which will not electrically shock people who touch or come into contact with it.

In accordance with this invention, a surface or substrate is primed by applying a sufficient number of layers of catalyzed primer 12 to the substrate 10 to prepare the substrate for subsequent layers. Up to five coats of catalyzed primer may be required. The substrate can be of metal, fiberglass, plastic or any other material that can be painted. The coat or coats of catalyzed primer are to be applied according to the manufacturer's instructions, with appropriate drying times after each layer. After the catalyzed primer has been applied, it is to be sanded until smooth, preferably with extra-fine or super-fine sandpaper.

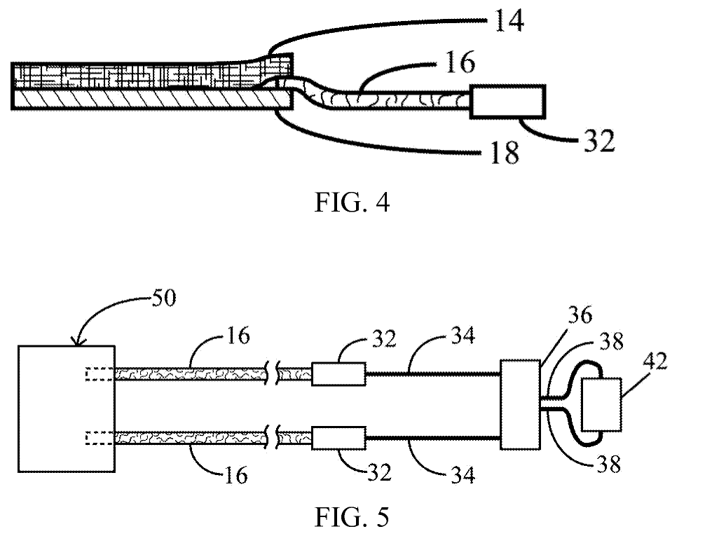

FIG. 4 shows the three layers which can be assembled together prior to being applied to the surface adjacent to the catalyzed primer. The three layers are: non-laminated electroluminescent material 18, conductive tape 16 and high-temperature-tolerant double-sided adhesive 14. The electroluminescent material and the high-temperature-tolerant double-sided adhesive can both be cut or shaped so that they are the size and shape of the desired design.

Electroluminescent material is known in the art. It gives a crisp, clear, high-visibility light by exciting light-emitting phosphors. It is frequently available as a polymer coated phosphor or electroluminescent tape. One brand, Lighttape®, is readily available, but is only sold commercially in a laminated form. The lamination protects the Lighttape® from moisture, which could reduce the life span or cause failure of the Lighttape®. However, the laminated Lighttape® is too thick to be used in this invention, as it is not easily embedded within layers of paint and other coatings to sit flush with the surface. Non-laminated Lighttape® or other electroluminescent material can overcome this problem as it provides a much thinner layer than the laminated material. This thinner profile makes it easier to install the electroluminescent material on the surface to which the design will be being applied, which enables it to more easily be made flush with the surface. However, without the lamination layer to protect it, the electroluminescent material can be degraded by paint and coating ingredients, or can fail due to moisture incursion, and high temperatures, such as those experienced by exposed surfaces of vehicles sitting in the sun, can cause adhesives to break down. Encasing the electroluminescent material in layers as shown in this invention can overcome these problems.

Any non-laminated electroluminescent material can be used in this invention, as long as it has a thin enough profile.

The electroluminescent material can be cut or otherwise shaped to the size and shape of the portion of the design which the user desires to illuminate, but cutting is not needed for most airbrushed or graphic designs. The user should then apply a sufficient number, generally two, pieces of double sided conductive tape with conductive adhesive 16, preferably one quarter to one-half inch, so they are partially overlapping and in contact with the surface of the electroluminescent material. Preferably, the double sided conductive tape should overlap the electroluminescent material by at least 1.5 cm. This tape can later be connected to the electrical connection on the electroluminescent material to enable the illumination of the design. If Lighttape® is used as the electroluminescent material, one piece of the conductive tape is to be attached to one side of the split electrode of the Lighttape®, and the other piece of conductive tape is to be attached to the second side of the split electrode. The conductor in the tape can be copper, aluminum, nickel or any other conductor. In the preferred embodiment, the conductive tape is to extend a minimum of 1.5 cm into the area of the design, but it can extend further. It can also extend less far, as long as there is a sufficient overlap to allow conductivity. As shown in FIG. 5, the pieces of conductive tape 16 are to extend only partially into the area of the design, shown generally at 50, and extend from within the area of the design until they ultimately terminate at and are attached to connectors 32. Ideally the connectors are flat, making them less obtrusive, and they can therefore more easily be hidden so as to not be easily observable. The connector also connects, either directly or through a conductor such as a wire 34 or other conductive medium, to a ballast 36 which generates the current and voltage flow to the electroluminescent material. The ballast can be several feet or even further from the design, and does not need to be on the same side of the surface as the design. Putting the ballast on a different side of the surface, such as the rear, allows the lighting mechanism to be hidden from view. Wires 38 can connect the ballast to a battery 42 or other power source which will provide the power to illuminate the electroluminescent material and hence the design.

The conductive tape or other conductive media will be buried in subsequent layers of clear coat and primer or two-part non-metallic glaze so that the surface of the final product will not be raised above the conductive tape or other conductive media. After the applications of the clear coat and the primer, the surface above the conductive media will be flat, making the conductive tape virtually imperceptible.

After the conductive tape has been applied to the electroluminescent material, a high-temperature-tolerant double sided adhesive 14, such as 4965 Tesa® is to be applied to the electroluminescent material and the portion of the conductive tape that covers the electroluminescent material, sandwiching a portion of the conductive tape between the electroluminescent material and the high-temperature-tolerant double sided adhesive. The adhesive used should be double sided and resistant to plasticisers, and it must bond well at elevated temperatures. The double-sided adhesive is to be cut so as it is the same size and shape as or slightly larger than the electroluminescent material, and fits over the electroluminescent material.

Once these three layers, the electroluminescent material, conductive media and high-temperature-tolerant double-sided adhesive, have been attached to one another, they are applied to the primed surface, with the double-sided adhesive side contacting the primed surface.

One or more coats of catalyzed clear coat 20 are applied to the non-laminated electroluminescent material. This helps seal the surface of the non-laminated electroluminescent material so it will not be damaged by contact with water or by moisture in the air. As many as three to five coats may be necessary in order to seal the electroluminescent material from ambient or surface moisture. All coats can be applied following the manufacturer's recommended flash times between coats. Once all the coats have been applied, they should be allowed to cure. They can then be sanded, preferably with extra-fine or super-fine sandpaper, or according to the manufacturer's instructions, prior to the application of the subsequent layer.

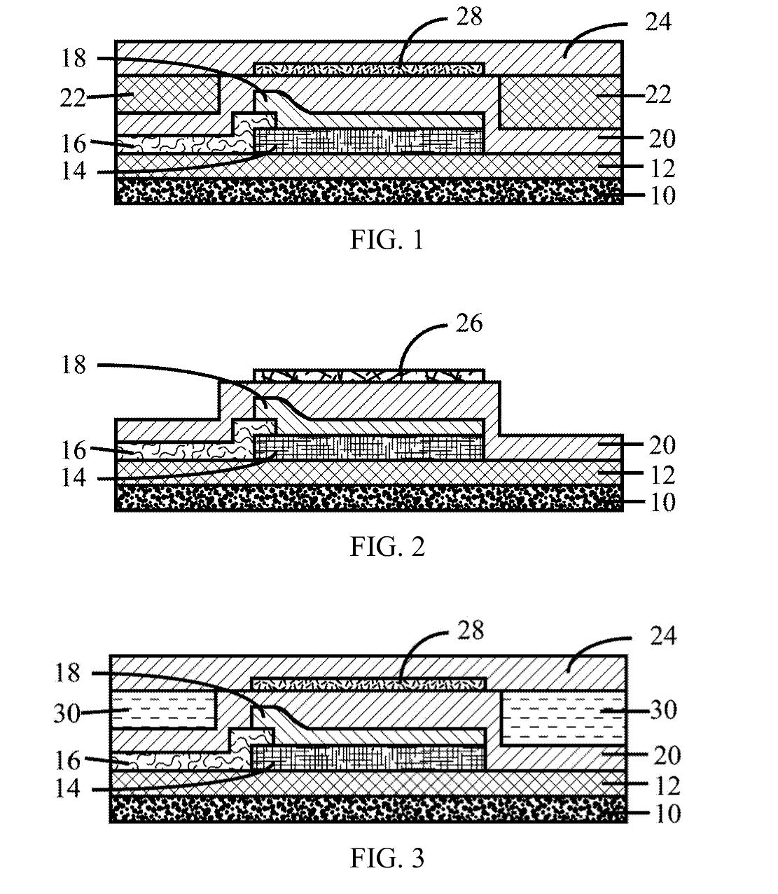

Next, the surface surrounding the electroluminescent material must be raised to the level of the surface over the electroluminescent material. This is accomplished by first applying a masking material 26 as shown in FIG. 2 to completely cover the surface over the electroluminescent material. The masking material will prevent the non-laminated electroluminescent material from being coated with the material which is used to raise the surrounding surface.

After the area over the electroluminescent material has been masked, catalyzed primer 22 is to be applied to the surrounding area, preferably by spraying onto the surface. If the design is being applied to a vehicle, the catalyzed primer can be sprayed as would normally be done when applying it to a vehicle. Preferably, this would require from three to seven coats. The manufacturer's recommended flash times between coats should be followed. Then the catalyzed primer is to be allowed to cure and be sanded with extra-fine or super-fine sandpaper or as per the primer manufacturer's recommendations. Alternatively, rather than using a catalyzed primer, a two-part non-metallic glaze or flowable polyester finishing and blending putty 30 can be applied as shown in FIG. 3. One appropriate two-part non-metallic glaze is Evercoat Easy Sand Flowable Putty. When using the two-part non-metallic glaze, should be applied with an applicator such as a putty knife. After it has dried, it should be sanded and primed as per the manufacturer's recommendations.

Once the surface of the area surrounding the non-laminated electroluminescent material has been raised to a level flush with the surface over the non-laminated electroluminescent material, the masking covering the non-laminated electroluminescent material is to be removed and the surface can be sanded.

After these steps have been completed, the design, artwork, or graphic can be applied as would normally be done. The design, artwork or graphic is to be applied over the electroluminescent material. If part of the design extends beyond the electroluminescent material, that part will not be capable of lighting up. Typically, applying the design will involve masking where appropriate to protect the area which is not to be painted, and masking the area which surrounds the desired design location. The first color 28 is then applied, and, when dry, the mask is to be removed. Multiple colors and fading and other effects can be used. If desired, this step can be repeated with a different mask covering a partially or completely different portion of the electroluminescent material and that portion can be painted with a different color. One type of paint that can be used for this portion of the application is Kandy Kolors™ from House of Kolors™

After the paint has dried, any remaining masking material is to be removed. Then several coats of catalyzed clear coat 24 are applied to the entire surface, including both over the electroluminescent material and over the surrounding area. The catalyzed clear coat should have good chemical, water and ultraviolet resistance. For vehicle applications, it should also have good fuel resistance. This step may require from three to twelve applications of clear coat. The clear coat can be cured and sanded after each coat, as per the manufacturer's recommendations.

While this invention has been described above and shown in the accompanying drawings, it should be understood that applicant does not intend to be limited to the particular details described above and illustrated in the accompanying drawings, but intends to be limited only to the scope of the invention as defined by the following claims.

What is claimed is:

1. A method for installing designs in surfaces, comprising the following steps:
priming the surface to which the design is to be applied with a catalyzed primer;
attaching to a piece of non-laminated electroluminescent material, at least one piece of a conductive tape having two ends, such that the first end at least partially overlaps the non-laminated electroluminescent material, and a piece of high-temperature-tolerant double-sided adhesive;
applying the combined non-laminated electroluminescent material, conductive material and high-temperature-tolerant double-sided adhesive tape to the location on the surface to which the design is to be applied in such a manner that the high-temperature-tolerant double sided adhesive tape contacts the primed surface; and
applying at least one coat of catalyzed clear coat to the surface.

2. The invention claimed in claim 1 which has the following additional steps:
masking the area over the electroluminescent material;
applying at least one coat of catalyzed primer to the surface; and
removing the masking from above the electroluminescent material.

3. The invention claimed in claim 1 which has the following additional steps:
applying masking to the area surrounding the electroluminescent material;
applying a first color to the electroluminescent material;
removing the masking from the area around the electroluminescent material; and
applying at least one coat of catalyzed clear coat to the area and the design.

4. The invention as claimed in claim 3 in which a design is painted on the first color.

5. The invention claimed in claim 1 in which the piece of high-temperature-tolerant double-sided adhesive is prepared so it is approximately the size and shape of the desired design.

6. A method for installing designs in surfaces, comprising the following steps:
priming the surface to which the design is to be applied with catalyzed primer;
attaching to a piece of non-laminated electroluminescent material, at least one piece of a conductive tape having two ends such that the first end at least partially overlaps the non-laminated electroluminescent material, and a piece of high-temperature-tolerant double-sided adhesive;
applying the combined non-laminated electroluminescent material, conductive material and high-temperature-tolerant double-sided adhesive tape to the location on the surface to which the design is to be applied in such a manner that the high-temperature-tolerant double sided adhesive tape contacts the primed surface; and
applying at least one coat of catalyzed clear coat to the surface.

7. The invention as claimed in claim 6 which has the following additional steps:
masking the area over the electroluminescent material;
applying a two-part non-metallic glaze; and
removing the masking from above the electroluminescent material.

8. The invention as claimed in claim 6 which has the following additional steps:
masking the area surrounding the electroluminescent material;
applying a first color to the electroluminescent material;
removing the masking from the area around the electroluminescent material; and
applying at least two coats of catalyzed clear coat to the area and the design.

9. The invention as claimed in claim 8 in which a design is painted on the first color.

10. The invention as claimed in claim 6 in which the piece of high-temperature-tolerant double-sided adhesive is prepared to be the size and shape of the desired design.

11. A design which can be applied to a surface, which is comprised of the following layers:
catalyzed primer;
double sided high-temperature-tolerant adhesive tape;
a partial layer of conductive tape;
non-laminated electroluminescent material; and
catalyzed clear coating.

12. The invention as claimed in claim 11 in which the design has the following additional layers:
first color; and
catalyzed clear coating.

13. The invention as claimed in claim 11 in which the design has the following layers:
first color;
painted design; and
catalyzed clear coating.

14. The invention as claimed in claim 11 in which the area surrounding the design has the following layers:
catalyzed primer; and
catalyzed clear coating.

15. The invention as claimed in claim 11 in which the area surrounding the design has the following layers:
two-part non-metallic glaze; and
catalyzed clear coating.

16. The invention as claimed in claim 11 in which a portion of the conductive tape extends beyond the edge of the design.

17. The invention as claimed in claim 16 in which one end of the conductive tape terminates at a connector.
